(19) United States
(12) Patent Application Publication
(10) Pub. No.: US 2012/0144053 A1
(43) Pub. Date: Jun. 7, 2012

(54) Light Weight Transformation for Media

(75) Inventors: Joseph Futty, Sammamish, WA (US); Danny Lange, Sammamish, WA (US); Ashley N. Feniello, Bothell, WA (US)

(73) Assignee: Microsoft Corporation, Redmond, WA (US)

(21) Appl. No.: 12/957,763

(22) Filed: Dec. 1, 2010

(51) Int. Cl. G06F 15/16

(52) U.S. Cl. 709/231

(57) ABSTRACT

A transform engine and/or transformation process may reduce computational resources used by a client, such as during the consumption of a media stream. According to some implementations, a media stream is received over a network. A mapping template may be associated with the media stream. A traversal of the mapping template may be performed without the accumulation of an intermediate state. Following the traversal of the mapping template, a transformed media stream may be communicated to a client for presentation.

### CROSS REFERENCE TO RELATED APPLICATION

This application is a continuation-in-part of, and claims priority to, co-pending U.S. patent application Ser. No. 12/737,168, filed on Jun. 9, 2010, entitled “Light Weight Transformation,” the entire disclosure of which is incorporated herein by reference.

### BACKGROUND

Third party media accessed by a client may be transformed using a transformation process. In general, the transformation process utilizes a processing engine to produce an output stream. The processing engine uses a matching template containing instructions that generally direct the processing engine to either create nodes in the result tree, or process more nodes. The output stream is generally derived from the result tree.

Consuming media from third party services may present obstacles for the client and/or the server. For example, when a client or a server retrieves a complex data structure from a third party service, the computational resources required to consume the data structure may be great and the time to create an output stream may be considerable. Generally, this may be the result of constructing an intermediate structure, such as an intermediate tree or index structure, dramatically increasing the resources and time required by the client or server to create and deliver the output stream.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Some implementations herein include a transformation engine and/or a transformation process to reduce computational resources used by a client and/or a server during the consumption of a media stream. In an example implementation, a media stream is received over a network. For example, the media stream may be a complex media stream, such as an arbitrarily complex set of one or many audio and video sources along with metadata. A mapping template may then be associated with the input stream. A traversal of the mapping template can be performed without the accumulation of an intermediate state. Following the traversal of the mapping template, a transformed stream may be emitted.

In some implementations, a transform engine is used to transform an input media stream. For example, the transform engine may manipulate and/or augment the input media stream as the input media stream flows through a transformation pipeline.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical items.

FIG. 1 is a schematic of an illustrative environment for a transformation framework.

FIG. 2 is a block diagram of an example computing device within the transformation framework of FIG. 1.

FIG. 3 is a block diagram of an example server within the transformation framework of FIG. 1.

FIG. 4 is a diagram of an example transformation process within the transformation framework of FIG. 1.

FIG. 5 is a diagram of an example transformation pipeline within the transformation framework of FIG. 1.

FIG. 6 is a diagram of an example mapping template within the transformation framework of FIG. 1.

FIG. 7 is a flow diagram of an example process to transform a media stream according to some implementations.

### DETAILED DESCRIPTION

Some implementations herein provide a transform engine and transformation processes to reduce computational resources used by a client or a server during consumption of a media stream. More specifically, an example process may transform a complex media stream, such as an arbitrarily complex set of one or many audio and video sources along with metadata, to a transformed output stream without allocating an intermediate tree or index structure. The transform engine receives the complex media stream and utilizes an associated mapping template to emit a transformed media stream.

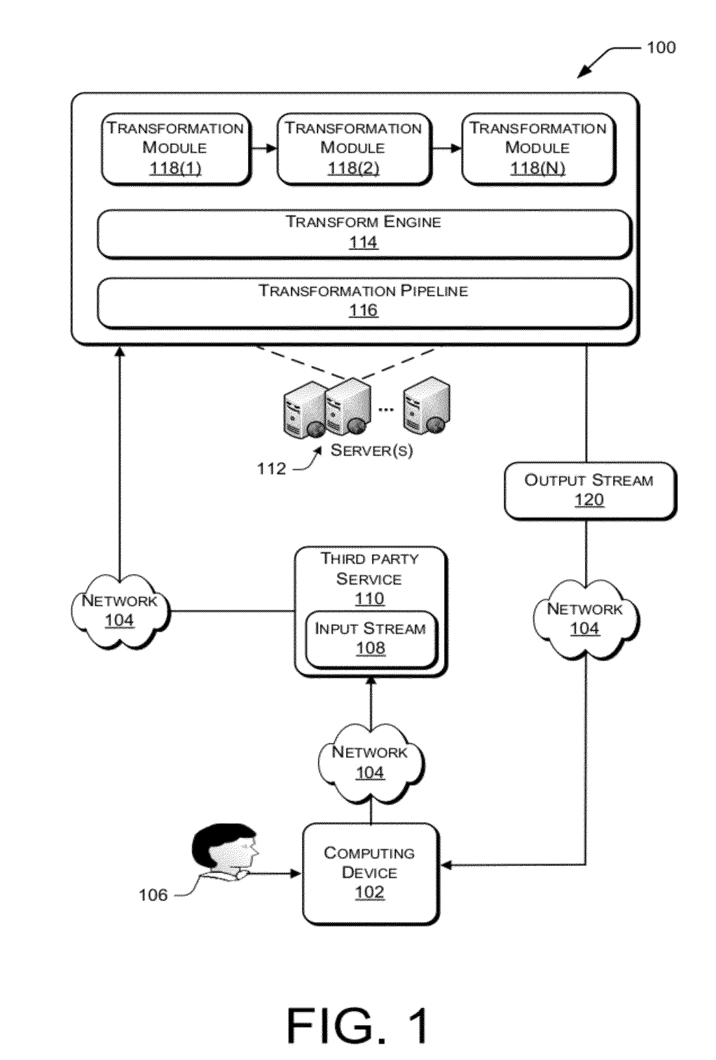

FIG. 1 is a block diagram of an example environment 100, which may be used as a framework for the transformation of media for consumption on a computing device. The environment 100 includes an example computing device 102, which may take a variety of forms including, but not limited to, a portable handheld computing device (e.g., a personal digital assistant, a smart phone, a cellular phone), a laptop computer, a desktop computer, a media player, a digital camcorder, an audio recorder, a camera, or any other similar device.

The computing device 102 may connect to one or more network(s) 104 and may be associated with a user 106. The computing device 102 may access a data transmission, such as an input stream 108, from a third party service 110. The third party service may provide access to one or more input streams 108 accessible by the computing device 102. Furthermore, the third party service 110 may operate on a server or other computing device having a structure similar to that of server 112 described herein. For example, in some implementations, third party service 110 may include a website provided by one or more web servers for providing media content to stream to a user 106 and computing device 102.

In some instances, the input stream may include substantially real-time content, non-real-time content, or a combination of the two. Sources of substantially real-time content generally include those sources for which content is changing over time, such as, for example, live television or radio, webcasts, or other transient content. Non-real-time content sources generally include fixed media readily accessible by a consumer, such as, for example, pre-recorded video, audio, text, multimedia, games, or other fixed media readily accessible by a consumer.

The input stream 108 may be communicated over network 104 to at least one server 112. The server 112 may include a transform engine 114, a transformation pipeline 116, and transformation module(s) 118(1)-118(N).

The transform engine 114 may include a transformation pipeline 116. The transformation pipeline including one or more transformation modules 118(1)-118(N). Each transformation module 118 may utilize one or more property parameters to carry out one or more transformation functions on the input stream 108 for transforming the input stream 108. The transformations may be performed in real time in parallel, sequentially, or a combination thereof. An output stream 120, including the desired transformed content stream, may be consumed by the computing device 102.

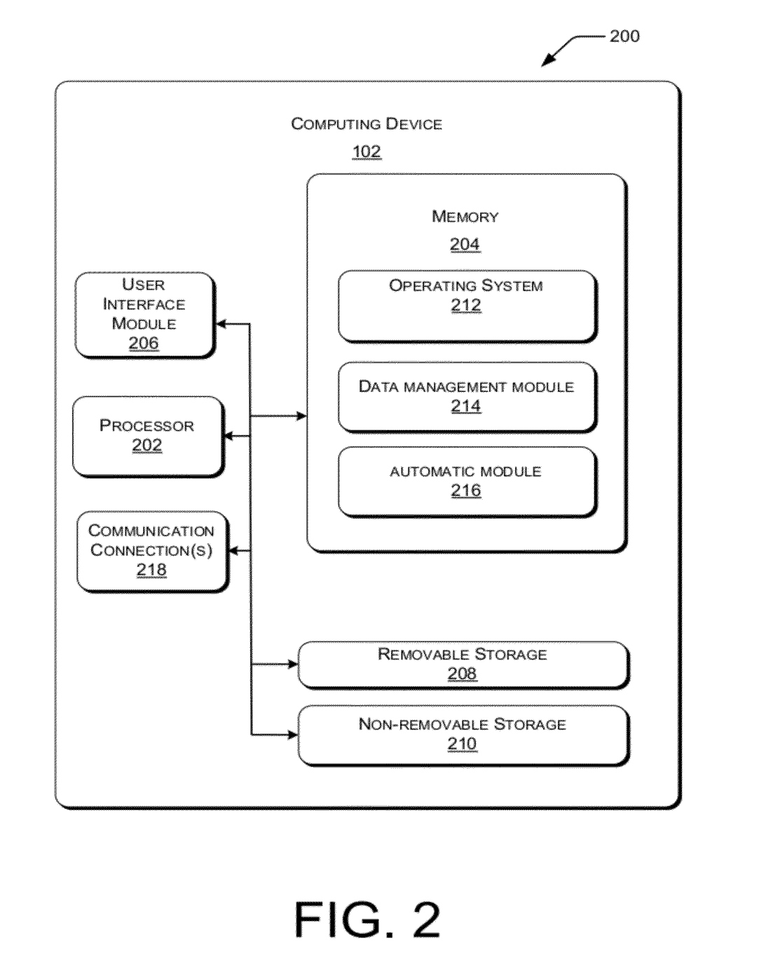

FIG. 2 is a schematic block diagram 200 of an example computing device 102. In one example configuration, the computing device 102 comprises at least one general processor 202, a memory 204, and a user interface module 206. The general processor 202 may be implemented as appropriate in hardware, software, firmware, or combinations thereof. Software or firmware implementations of the general processor 202 may include computer or machine executable instructions written in any suitable programming language to perform the various functions described.

Memory 204 may store programs of instructions that are loadable and executable on the processor 202, as well as data generated during the execution on these programs. Depending on the configuration and type of server, memory 204 may be volatile (such as RAM) and/or non-volatile (such as ROM, flash memory, etc.). The computing device 102 may also include additional removable storage 208 and/or non-removable storage 210 including, but not limited to, magnetic storage, optical disks, and/or tape storage. The disk drives and their associated computer-readable medium may provide non-volatile storage of computer readable instructions, data structures, program modules, and other data for the computing device 102.

Memory 204, removable storage 208, and non-removable storage 210 are all examples of computer storage media. Examples of suitable computer storage media that may be present include, but are not limited to, RAM, ROM, flash memory or other memory technology, CD-Rom, DVD, or other optical storage magnetic cassettes, magnetic tape, magnetic disk storage (e.g., floppy disc, hard drive) or other magnetic storage devices, or any other medium which may be used to store the desired information. In some implementations, the memory 204, removable storage 208, and non-removable storage 210 may be non-transitory computer-readable media.

Turning to the contents of memory 204 in more detail, the memory may include an operating system 212. In one implementation, the memory 204 includes a data management module 214 and an automatic module 216. The data management module 214 stores and manages storage of information, such as images, return on investment (ROI), equations, and the like, and may communicate with one or more local and/or remote databases or services. The automatic module 216 allows the process to operate without human intervention. The computing device 102 may also contain communication connection(s) 218 that allow processor 202 to communicate with other services. Communications connection(s) 218 is an example of a communication medium. A communication medium typically embodies computer-readable instructions, data structures, and program modules. By way of example and not limitation, communication medium includes wired media such as a wired network or direct-wired connection, and wireless media such as acoustic, RF, infrared and other wireless media.

The computing device 102, as described above, may be implemented in various types of systems or networks. For example, the computing device may be a stand-alone system, or may be a part of, without limitation, a client server system, a peer-to peer computer network, a distributed network, a local area network, a wide area network, a virtual private network, a storage area network, and the like.

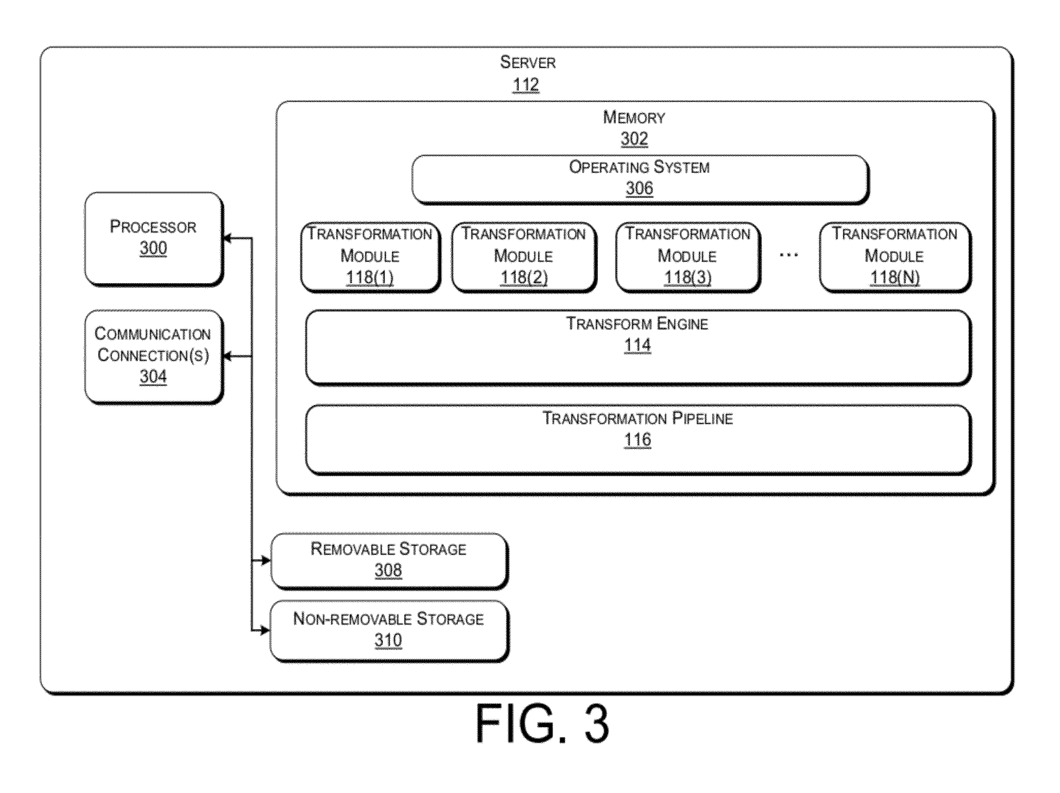

FIG. 3 illustrates an example server 112. The server 112 may be configured as any suitable system capable of services. In one example configuration, the server 112 comprises at least one processor 300, a memory 302, and a communication connection(s) 304. The communication connection(s) 304 may include access to a wide area network (WAN) module, a local area network module (e.g., WiFi), a personal area network module (e.g., Bluetooth®), and/or any other suitable communication modules to allow the server 112 to communicate over the network(s) 104.

Turning to the contents of the memory 302 in more detail, the memory 302 may store an operating system 306, the transform engine 114, the transformation pipeline 116, and one or more transformation modules 118(1)-118(N). While the transform engine 114 is illustrated in this example as a component within the server 112, it is to be appreciated that the transform engine may alternatively be, without limitation, a component within the computing device 102 or a standalone component.

The server 112 may also include additional removable storage 308 and/or non-removable storage 310. Any memory described herein may include volatile memory (such as RAM), nonvolatile memory, removable memory, and/or non-removable memory, implemented in any method or technology for storage of information, such as computer-readable instructions, data structures, applications, program modules, emails, and/or other content. Also, any of the processors described herein may include onboard memory in addition to or instead of the memory shown in the figures. The memory may include storage media such as, but not limited to, random access memory (RAM), read only memory (ROM), flash memory, optical storage, magnetic disk storage or other magnetic storage devices, or any other medium which can be used to store the desired information and which can be accessed by the respective systems and devices.

The server as described above may be implemented in various types of systems or networks. For example, the server may be part of, including but is not limited to, a client-server system, a peer-to-peer computer network, a distributed network, an enterprise architecture, a local area network, a wide area network, a virtual private network, a storage area network, and the like.

Various instructions, methods, techniques, applications, and modules described herein may be implemented as computer-executable instructions that are executable by one or more computers, servers or computing devices. Generally, program modules include routines, programs, objects, components, data structures, script referencing other objects, etc. for performing particular tasks or implementing particular abstract data types. These program modules and the like may be executed as native code or may be downloaded and executed, such as in a virtual machine or other just-in-time compilation execution environment. The functionality of the program modules may be combined or distributed as desired in various implementations. An implementation of these modules and techniques may be stored on or transmitted across some form of computer-readable media.

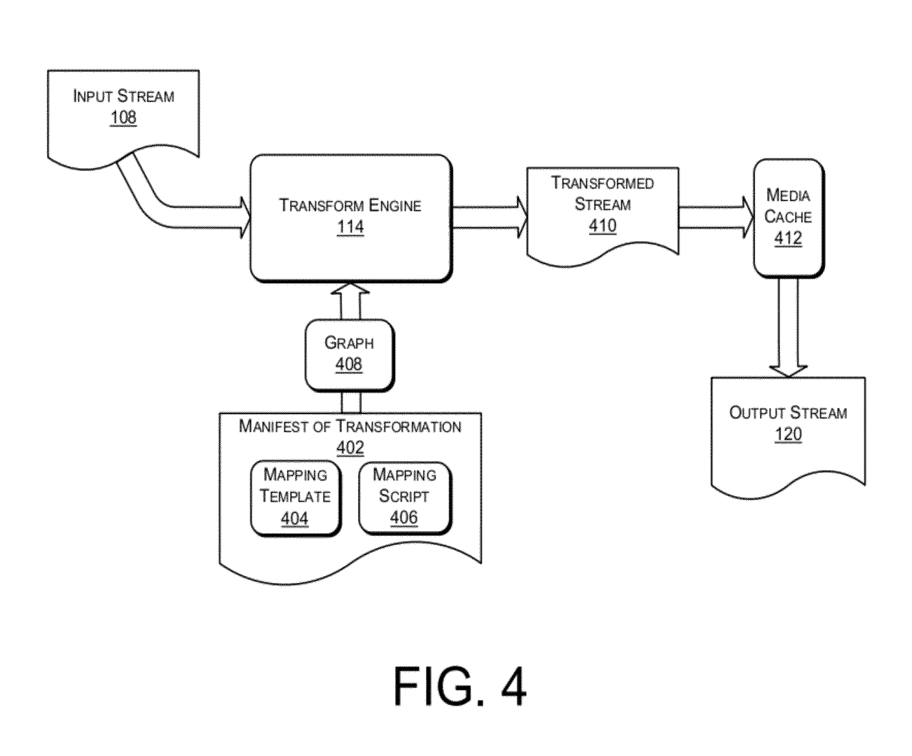

FIG. 4 illustrates an example transformation process 400. The computing device 102 communicates an input stream 108. In one implementation, input stream 108 is a media stream including an audio stream, a video stream or a combination thereof. In some instances, the input stream 108 may be an arbitrarily complex set of one or many audio and video sources along with metadata. The transform engine 114 generally also takes in a manifest of transformation 402. The manifest of transformation 402 may include a mapping template 404 and a mapping script 406. The manifest of transformation 402 may be hosted externally of the transform engine 114, hosted on the server 112, or embedded into the transform engine 114.

The mapping template 404 may be a graph typically constructed prior to the transformation process and is accessible for multiple requests by the transform engine 114. For example, the mapping template 404 expresses a graph 408 of transformation modules 118 and may be turned into the perspective of the input stream graph based upon inferences made from one or more matching expressions. The matching expressions are determined on a traversal of the input stream 108. A match expression results, indicating where to find specific data in the mapping template. Multiple matches may produce multiple results.

The mapping template may be pivoted into the perspective of the input stream 108 using the matching expressions described above. Therefore, the actual work performed by the transform engine 114 is minimal at the time of the transformation process. For example, the transform engine 114 may process incoming data contained within the input stream 108 as the input media streams over the network 104, without building up any intermediate per-request data structures.

In some instances, the mapping template 404 may include one or more transformation modules 118(1)-118(N) making up the transformation pipeline 116. One or more mapping templates 404 may be typically designed to optimize a sequence of operations within the transformation process. For example, performing a resize operation prior to performing a facial recognition operation.

Each of the transformation modules 118 may manipulate and/or augment the input stream as the input stream 108 flows through the transformation pipeline 116. For example, the transformation modules 118 may, without limitation, resize, add content, add meta data for enhanced media players, translate a spoken language to another language, add closed captioning, add meta data about items recognizable for commercial purposes, filtering, interleaving, merging, cropping, aggregate transformations consisting of two or more transformations, and the like. The transformation modules may be created by a third party service or source, and may include the properties the transformation module consumes during the transformation process. In some instances, the transformation modules may be customized to the user 106. For example, the user may have previously indicated that the user's desired language is French. Therefore, the transformation pipeline may include a transformation module translating the input stream 108 to French. The transform engine 114 may pass a transformed stream 410 through the media cache 412, resulting in the final output stream 120.

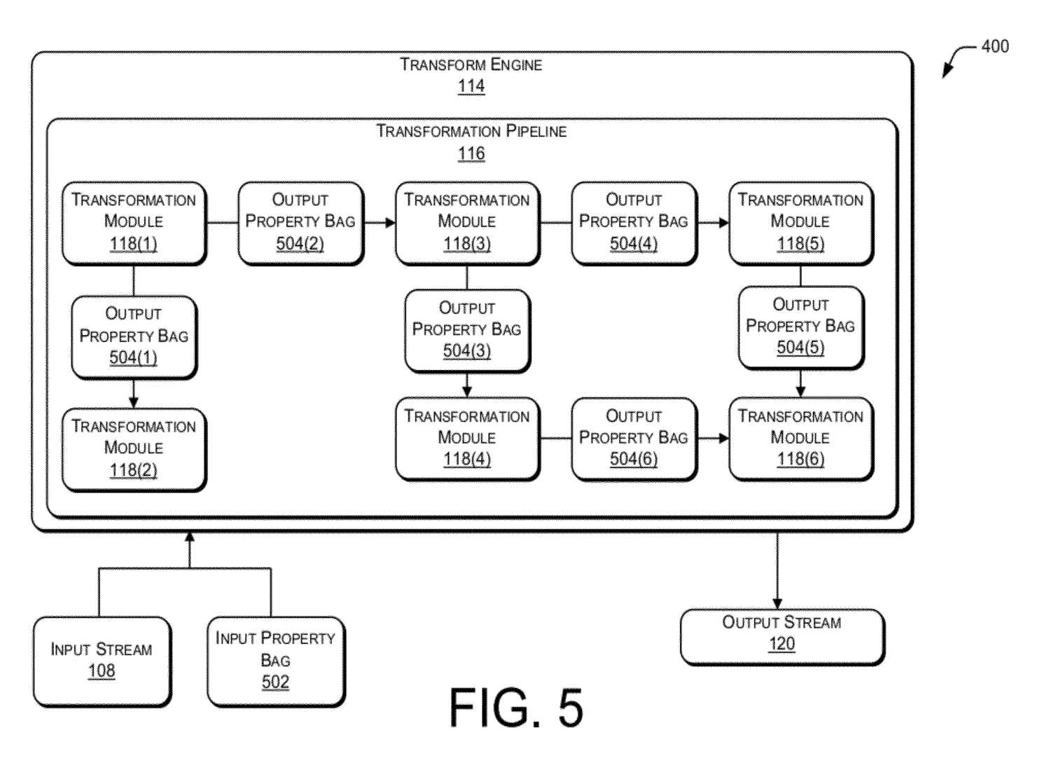

As illustrated in FIG. 5, once the appropriate mapping template to be used during the transformation process is determined, the transform engine generally takes in the input stream 108 and an input property bag 502. The input property bag 502 may consist of one or more parameters utilized by the transform engine 114. Each transformation module 118 uses those parameters associated with the transformation. Parameters not essential to the transformation are transmitted in an output property bag 504(1)-504(N) to the next transformation module in the transformation pipeline. The output property bag may also include new property parameters produced by an upstream transformation module. Parameters passed from transformation module to transformation module remain implicit. The transformation pipeline 116 accretes the transformed content from multiple transformation modules 118 into a single composition taking initial discrete units in the input stream 108 and producing the output stream 120.

In some instances, the input stream 108 may enter the transform engine 114 in the form of a virtually continuous stream in discrete units. For example, without limitation, a video may be split into video frames or by metadata. The transform engine 114 may traverse the transformation modules 118 within the mapping template 404 in real time in parallel or sequentially and the transformation modules 118 may consider any or all of the discrete units.

In one implementation, the input stream 108 may be transformed into discrete units to guide the transform engine 114 through the mapping template 404. For example, the transform engine 114 may perform the transformation as follows: as the discrete units are streaming in over network 104 to the transform engine 114, the transformation module 118(1) recognizes the associated transformation along with the properties to perform the transformation from the input property bag 502. The stream is passed to another transformation module 118(2) along with the output property bag 504(1). This process continues until the transformation process is complete.

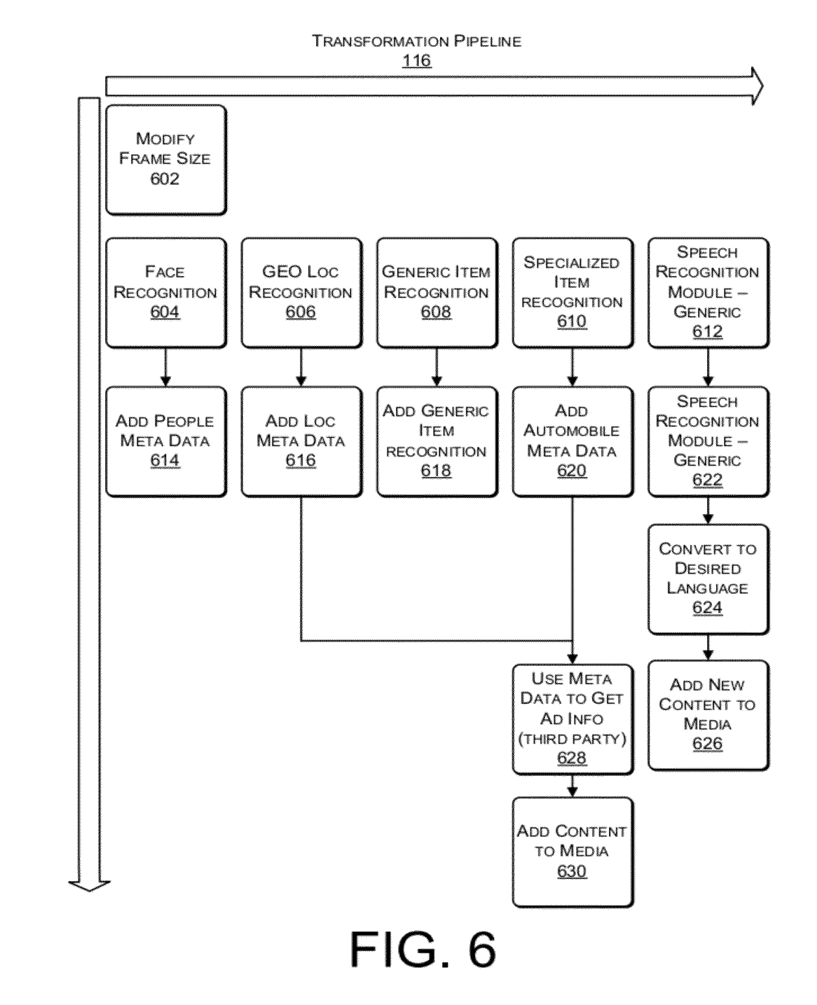

FIG. 6 illustrates an example mapping template to perform a desired transformation process for input stream 108. The mapping template consists of a number of transformation modules 602-630 that may be traversed either in parallel or sequentially. In this example the transformation modules are: a modify frame size module 602, a face recognition module 604, a GEO Loc Recognition module 606, generic item recognition module 608, a specialized item recognition module 610, a speech recognition module-generic 612, an add people meta data module 614, an add location meta data module 616, an add generic item recognition module 618, an add automobile meta data module 620, a speech recognition module-generic 622, a convert to desired language module 624 an add new content to media module 626, a user meta data to get ad information from a third party module 628, and an add content to media module 630. Although not shown in FIG. 6, basic modules may be available prior to the modify frame size module 602 to perform tasks such as filtering, interleaving, and merging of data in preparation for feeding the data into modules performing more complex transformations. In some instances, a number of basic modules may be used in combination to build up a level of complexity. For example, one module may be able to take multiple video sources at various frame rates and interpolate to match or convert to a least common rate. Each of the transformation modules may be designed/authored by the same author or by different authors. In either scenario, it is desirable to have the transformation module authors document the properties that each of the transformation modules consume. These documented properties may be considered when creating the mapping templates outlining various transformation processes. For example, placing location specific advertising into a video stream. One transformation module may perform speech-to-text conversion, producing a VoiceText property. Another transformation module may consume this information looking for location references (e.g., city names, landmarks, etc.), producing a LocRef property. A third transformation module may geocode locations, producing latitude and longitude (LatLon). And an advertising module may consume the LatLon along with the VoiceText from the first module to produce context sensitive local advertisements. In this example, the speech-to-text module is loosely connected to both the LocRef and the advertising module.

In some instances, there may be a higher order system by which modules themselves may be referred to as data and added to the output property bag 504. Transformation modules downstream in the transformation pipeline 116 may use these modules to form new modules.

In some instances, the transformation modules are encouraged to persist in any accumulated state in the mapping template. In such an instance, a private node within a given namespace may be allowed and may be accessible only by the associated transformation module. However, this private state is known to the server 112, allowing the server to suspend and resume processing, to delegate work, at the server's discretion and without the knowledge of the transformation modules within the mapping template.

Transformation modules may also accumulate data based upon previously observed discrete units. There is occasion to look ahead into a future transformation and use previously utilized information to produce transformations in the present. For example, a speech-to-text module feeding a language transition module, and in turn feeding a transformation module to produce subtitle overlays. Generally, subtitles are displayed before the audio is heard. Therefore, the process of adding subtitles may be accomplished by the subtitle module consuming and accumulating the input stream 108 while not yielding output to the next transformation module in the transformation pipeline 116. Such an example may cause a delay in the entire transformation pipeline and may cause an increase in memory use. However, as in this example, the delay may take place in certain transformation process.

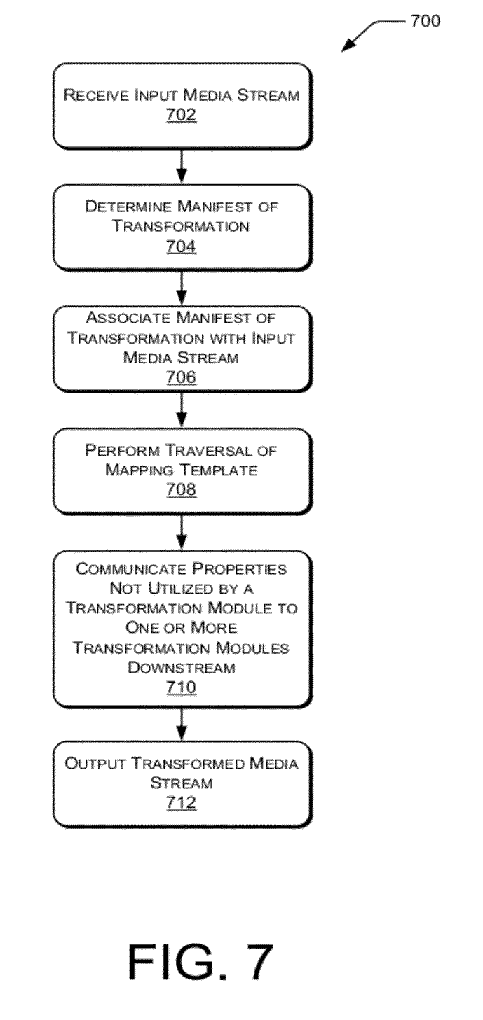

FIG. 7 illustrates a flow diagram of an example process 700 outlining the media transformation process according to some implementations herein. In the flow diagram, the operations are summarized in individual blocks. The operations may be performed in hardware, or as processer-executable instructions (software or firmware) that may be executed by one or more processors. Further, the process 700 may, but need not necessarily, be implemented using the framework of FIG. 1.

At block 702, an input stream is received by the transform engine 114. The input stream may be a video stream, an audio stream, or an set of one or more many audio and video sources containing meta data.

At block 704, a manifest of transformation is determined for the desired transformation process. The manifest of transformation may include a mapping template 404 and a mapping script 406 to set for an optimal sequence for the transformation of the input stream 108.

At block 706, the manifest of transformation is associated with the input stream 108. As described with respect to block 704, the manifest of transformation may include a mapping template and a mapping script. The mapping template may include one or more transformation modules making up the transformation pipeline 116. Each of the transformation modules may manipulate and/or augment the input stream as it flows through the transformation pipeline.

At block 708, the transform engine 114 traverses the transformation modules within the mapping template 404 in real time in parallel or sequentially.

At block 710, properties not utilized by a transformation module are communicated to one or more transformation modules downstream in the transformation pipeline. For example, each transformation module uses those parameters associated with the transformation. Parameters not essential to the transformation are transmitted in an output property bag 504(1)-504(N) to the next transformation module in the transformation pipeline. The output property bag may also include new property parameters produced by an upstream transformation module.

At block 712, a transformed output stream 120 is communicated to and presented on the computing device 102.

### CONCLUSION

Although a transformation process for the transformation of an input media stream using a mapping template has been described in language specific to structural features and/or methods, it is to be understood that the subject of the appended claims are not necessarily limited to the specific features or methods described. Rather, the specific features and methods are disclosed as example implementations.

What is claimed is:

1. A computer-implemented method comprising:
receiving a media stream over a network;
associating, by a processor, a manifest of transformation with the media stream, the manifest of transformation comprising a mapping template and a mapping script;
performing a traversal of the mapping template as the media stream is transmitted over the network free from an intermediate state; and
outputting a transformed media stream.

2. The computer-implemented method of claim 1 further comprising receiving a property bag comprising one or more transformation properties

3. The computer-implemented method of claim 2, wherein the mapping template comprises a transformation pipeline composed of one or more transformation modules, each transformation module corresponding to a transformation property.

4. The computer-implemented method of claim 3, further comprising communicating a transformation property not utilized by a transformation module to one or more downstream transformation modules in the transformation pipeline.

5. The computer-implemented method of claim 1, wherein the traversal of the mapping template is a real time parallel traversal.

6. The computer-implemented method of claim 1, wherein the traversal of the mapping template is a real time sequential traversal.

7. The computer-implemented method of claim 1, wherein the media stream comprises an audio stream, a video stream or a combination thereof.

8. A system comprising:
a memory;
one or more processors coupled to the memory;
a transform engine operable on the one or more processors, the transform engine configured to:
receive an input media stream;
receive an input property bag comprising one or more transformation properties;
determine a mapping template associated with the input stream;
traverse the mapping template in real time; and
output a transformed media stream.

9. The system of claim 8, wherein the mapping template comprises one or more transformation modules, each of the transformation modules configured to manipulate and/or augment the input media stream as it flows through the one or more transformation modules.

10. The system of claim 9, wherein the one or more transformation modules comprise at least one of a resize module, an add content module, an add meta data for enhanced media players module, a translate a spoken language to another language module, an add closed captioning module, an add meta data about items recognizable for commercial purposes module, a filtering module, an interleaving module, a merging module, and/or a cropping module.

11. The system of claim 10, wherein one or more transformation modules are used in a combination, permitting the module to receive multiple input media streams from multiple sources.

12. The system of claim 8, wherein the input stream may be received in a continuous stream of one or more discrete units.

13. The system of claim 11, wherein the one or more discrete units are considered by one or more transformation modules making up the mapping template.

14. The system of claim 13, wherein one of the one or more transformation modules recognizes a transformation to be performed by another transformation module, associates one or more transformation properties to perform the transformation, and passes the one or more discrete units to the other transformation module.

15. The system of claim 8, wherein the traversal of the mapping template is a sequential traversal and/or a parallel traversal.

16. One or more computer-readable media storing computer-executable instructions that, when executed on one or more processors, cause the one or more processors to perform operations comprising:
receiving an input stream transmitted over a network;
associating a mapping template with the input stream, the mapping template comprising a transformation pipeline including one or more transformation modules; and
employing a transformation property associated with the input stream to manipulate the input stream within the transformation pipeline.

17. The one or more computer-readable media of claim 16, the operations further comprising traversing the mapping template in a parallel order or a sequential order.

18. The one or more computer-readable media of claim 16, the operations further comprising communicating additional transformation properties to a downstream transformation module, the additional transformation properties comprising at least an upstream transformation module.

19. The one or more computer-readable media of claim 16, wherein the input stream comprises one or more discrete units, each discrete unit considered by a transformation module permitting an accumulation of data based upon a transformation performed on a previously viewed discrete unit.

20. The one or more computer-readable media of claim 16, the operations further comprising transmitting a property bag comprising at least one additional transformation property not utilized by an upstream transformation module to a downstream transformation module.
